(19) United States
(12) Patent Application Publication
(10) Pub. No.: US 2024/0070610 A1
(43) Pub. Date: Feb. 29, 2024

(54) COMPUTER VISION SHELF AUDITING

(71) Applicant: NCR Corporation, Atlanta, GA (US)

(72) Inventors: Naveen Kumar Ponnaganti, Tampa, FL (US); Tharun Kumar Ponnaganti, Nalgonda (IN); Sanketh Bachoti, Hyderabad (IN); Akansha Prakash Chourasia, Nagpur (IN); Prasanna Rajasree Mattupalli, Naguluppalapadu (IN); Yaswanth Sai Velamur, Atmakur (IN); Shashank Vishwanatham, Hyderabad (IN)

(21) Appl. No.: 17/900,038

(22) Filed: Aug. 31, 2022

(51) Int. Cl. G06Q 10/08; G06V 10/25; G06V 10/74; G06V 20/00; G06V 20/52

(52) U.S. Cl. CPC G06Q 10/087; G06V 10/25; G06V 10/74; G06V 20/36; G06V 20/52

(57) ABSTRACT

A machine-learning model (MLM) is trained to identify a given item identifier for an item and shelf dimensions of an empty space associated with the item from training images of a shelf. After training, real-time images of the shelf are provided as input to the MLM and the output provided by the MLM includes empty space identifiers, dimensions or pixel coordinates for each empty space identifier, and an item identifier for each empty space identifier. A quantity of each item identifier is determined based on known shelf dimensions that the corresponding item should occupy on a fully stocked shelf and based on the corresponding empty space dimensions for the empty space associated with the item. A real-time report is sent to store personnel and/or published on a website monitored by the store personnel. The report identifies the items, the shelves, and restocking item quantities that need restocked in the store.

### BACKGROUND

Currently retailers deploy employees to manually check missing items on shelves, which is inefficient, time consuming, and fraught with oversight errors. Even when retailers rely on transactional data from their point-of-sale (POS) systems for in-store inventory, the data does not update in real time and can be inconsistent with the actual shelf inventory. These problems cause restocking operations to be slow and often result in popular items missing from shelves for longer than is necessary.

The retailers experience lost opportunity sales when the shelves are not adequately stocked. Customers may frequent different stores associated with different retailers resulting in a loss of customer loyalty. Customers may become frustrated and post adverse comments on social media, which may result in potential or existing customers, who did not experience any out-of-stock items, intentionally avoiding the retailer's store or the retailer altogether.

Thus, timely and accurately restocking items on shelves of a store is of significant import to the retailer. Even a one-time lapse in timely restocking by a retailer can have long lasting negative consequences for that retailer.

### SUMMARY

In various embodiments, methods and a system for computer vision shelf auditing are presented. A machine-learning model (MLM) is trained on images of store shelves to identify items and shelf dimensions or pixel coordinates of empty spaces on the shelves that are associated with the items. Real-time images of the shelves are provided to the MLM and item identifiers for the items, empty space identifiers for the corresponding items, and empty space dimensions or pixel coordinates for the empty space identifiers are provided as output from the MLM. For each item identifier and empty space dimensions or pixel coordinates, a total quantity that needs to be restocked on a corresponding shelf with the corresponding item is calculated. A real-time report is sent to store personnel or published to a website monitored by the store personnel for the personnel to restock the shelves in near real time at the store. This ensures that store shelves are continuously and regularly restocked.

According to an aspect, a method of computer vision shelf auditing is presented. A real-time image of a shelf in a store is provided to a machine-learning model (MLM) as input. An empty space identifier for an empty space on the shelf and an item identifier for an item associated with the empty space are received as output from the MLM. A quantity of the item is determined, the quantity corresponds to the empty space and is based on known dimensions for a single item associated with the item identifier. A shelf identifier for the shelf, the empty space identifier for the empty space, the item identifier for the item, and the quantity are reported for real-time restocking of the item on the shelf of the store.

### BRIEF DESCRIPTION OF THE DRAWINGS

FIG. 1A is a diagram of system for computer vision shelf auditing, according to an example embodiment.

FIG. 1B is a diagram of an example control file used for training a machine-learning model (MLM) for computer vision shelf auditing, according to an example embodiment.

FIG. 1C is a diagram depicting example shelves stocked with example items, according to an example embodiment.

FIG. 1D is diagram depicting the shelves of FIG. 1C edited to identify missing items from the shelves, according to an example embodiment.

FIG. 1E is a screenshot that depicts a restocking audit report of shelves depicted in FIG. 1C, according to an example embodiment.

FIG. 2A is a flow diagram of a method for computer vision shelf auditing, according to an example embodiment.

FIG. 2B is a flow diagram of embodiments of the method of FIG. 2A.

FIG. 3A is a flow diagram of another method for computer vision shelf auditing, according to an example embodiment.

FIG. 3B is a flow diagram of embodiments of the method of FIG. 3A.

### DETAILED DESCRIPTION

As stated above, timing restocking of items on shelves of stores can have a significant impact on the business of a store. A store can experience customer turnover when shelves are not properly restocked with the frustrated customers going to other stores to find their items and a chance of the customers never frequenting the store again.

As will be demonstrated herein and below, a machine-learning model is trained on images and/or a video stream taken of shelves of the store for purposes of recognizing the items and identifying missing items by empty spaces identified on the shelves from the images/video. An alert or a report is sent to staff of the store identifying the missing items and the corresponding shelves. Additionally or alternatively, the alert or report is published on a website monitored by store personnel in real time. This permits timely and real-time item restocking at the store, which the industry has been unable to be achieve by just relying on the accuracy of transaction records and the diligence of staff who periodically perform manual inspection of store shelves.

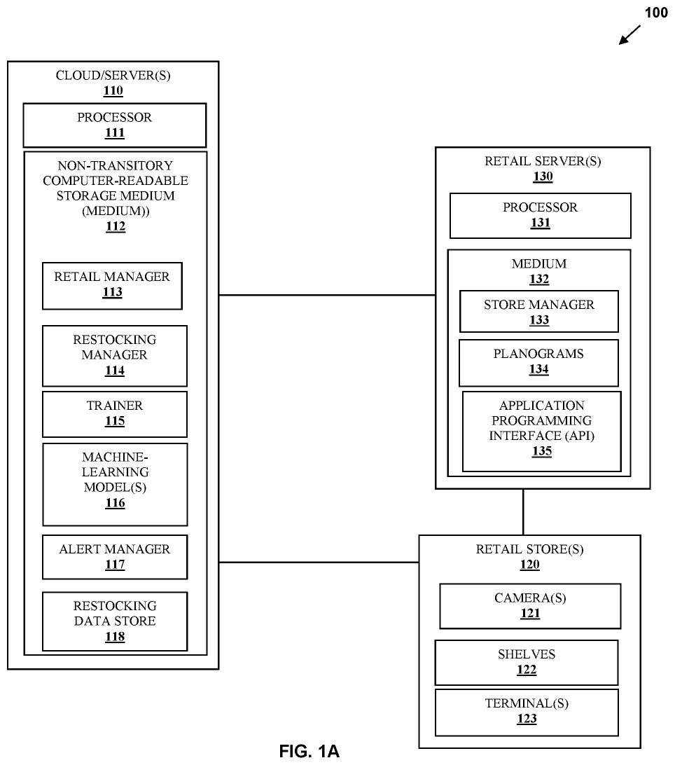

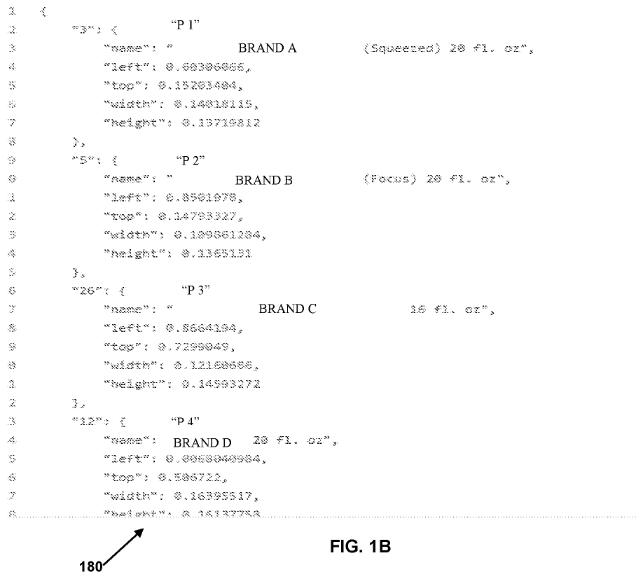

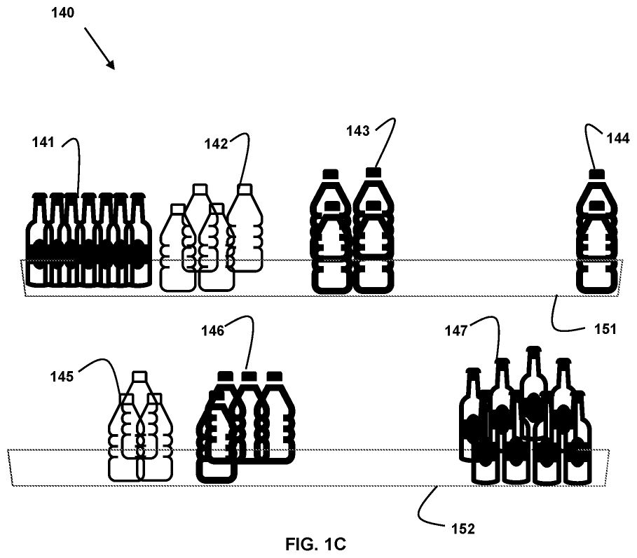

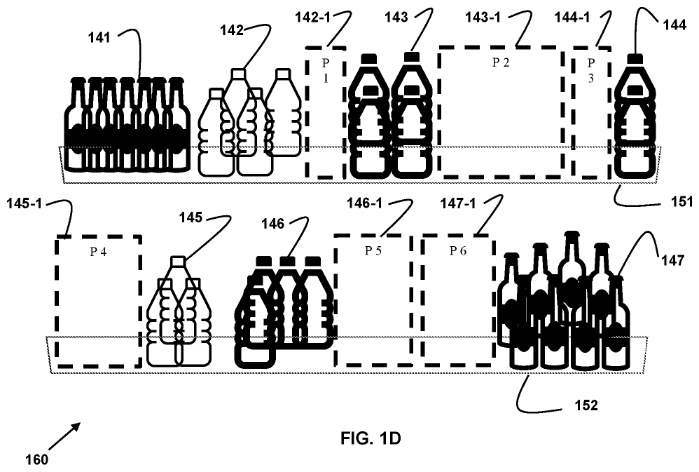

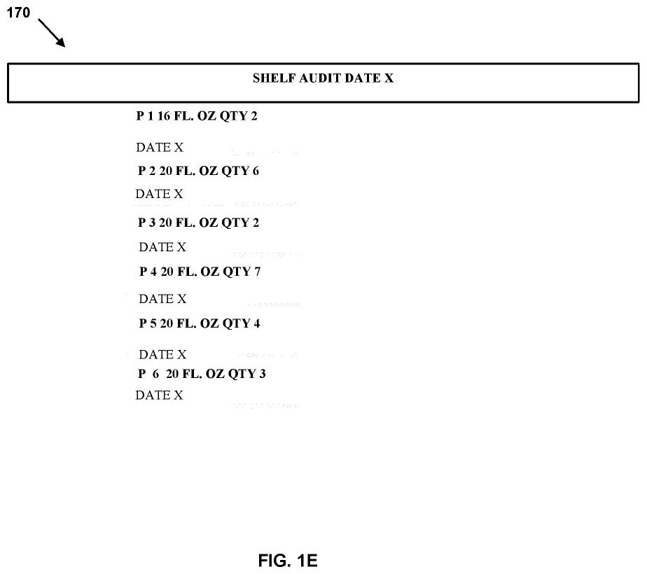

FIG. 1A is a diagram of a system 100 for computer vision shelf auditing, according to an example embodiment. It is to be noted that the components are shown schematically in greatly simplified form, with only those components relevant to understanding of the embodiments being illustrated.

Furthermore, the various components (that are identified in the FIG. 1A) are illustrated and the arrangement of the components is presented for purposes of illustration only. It is to be noted that other arrangements with more or fewer components are possible without departing from the teachings of computer vision shelf auditing, presented herein and below.

As used herein, the terms “staff,” “staff member,” “employee,” “store personnel,” “personnel,” and/or “store employees” can be used interchangeably and synonymously herein and below. These terms refer to the individual to which item restocking alerts or reports are sent to or monitored by.

System 100 includes a cloud 110 or a server 110 (hereinafter just “cloud 110”), a retail store 120, and retail servers 130. Cloud 110 includes at least one processor 111 and a non-transitory computer-readable storage medium 112, which includes executable instructions for a retail manager 113, a restocking manager 114, a trainer 115, one or more machine-learning models (MLMs) 116, and an alert manager 117. Medium 112 also includes a restocking data store 118. The instructions when executed by processor 111 cause processor 111 to perform operations relevant to 113-117 as discussed herein and below.

Each retail store 120 includes cameras 121, shelves with items stocked thereon, and terminals 123. It is noted that each retail store 120 can also include a store server with a processor, a medium, and executable instructions, which are executed by the processor for purposes of interacting and reporting transaction data from transaction performed on terminals 123.

Each retail server 130 includes at least one processor 131 and a non-transitory computer-readable storage medium 132, which includes executable instructions for a store manager 133 and an Application Programming Interface (API) 135. Medium 132 can also include planograms for each of stores of the corresponding retailer. The executable instructions when executed by processor 131 cause processor 131 to perform operations relevant to store manager 133 and API 135 as discussed herein and below.

Initially, retail manager 113 interacts with API 135 to receive planograms 134 for stores 120 of the retailer. Store manager 133 configures cameras 121 of the stores for sending or making available, in a file or data store accessible to cloud 110, images of video captured in real time by cameras 121. The images or video streams are streamed to memory buffers, files, or data stores accessible to cloud 110.

Trainer 115 uses a store's planogram 134 and metadata associated with the images or video stream, to label features in the images. The metadata can include a camera identifier, a camera location, a retailer identifier, a store identifier, and shelf identifiers associated with shelves 122 of the store 120 that the field-of-view of the corresponding camera 121 captures in the corresponding image or video stream. The store's planogram provides Item identifiers for each item, shelf identifiers for each shelf 122, dimensions on the corresponding shelf that each type of an item having a same item identifier appears on the corresponding shelf 122, and optionally a total item count for each type of item on a given shelf 122. This enables trainer 115 to produce training images or training video for each shelf 122 of each store 120. The training images or training video are labeled within input training features by trainer 115, the input training features labeled include a retailer identifier for the retailer, a store identifier for the store 120, shelf identifiers for the shelves in the corresponding training image or training video, item type identifiers for item types on each shelf 122, item identifiers for the items associated with each item type, and the shelf dimensions for a given shelf 122 associated with a given item type identifier that occupies the corresponding shelf dimensions. The labeled shelf dimensions, for a given shelf of a given item type associated with a same item identifier, are obtained from the planogram by trainer 115. The retailer identifier, store identifier, camera identifier, and shelf identifiers are obtained from the metadata associated with a given training image or a given frame of the training video. The labeled training images or training video are used as features provided as input with the training images or training video to MLM 116 during a training session.

The trainer 115 also provides as input, during a training session with MLM 116, a control file or control data structure associated with the shelves and the items, The control file or control data structure includes image coordinates for a given item type on a given shelf. That is, for a given type of item all having a same item identifier and a given image captured by a given camera 121, the pixel coordinates of the items having the item type on the shelf within the image are noted in a control file/data structure. This gives the pixel coordinate for the top of the items on the shelf, the leftmost pixel coordinate for the items on the shelf, the height of the items expressed as a bottom coordinate for the items on the shelf, and the width of the items expressed as a rightmost coordinate for the items on the shelf. The four coordinates allow the MLM 116 to disambiguate between two different item spaces based on the pixel coordinates in the control file/data structure and based on the identified pixel coordinates associated with a given identified empty space in an image. This file/data structure can be maintained per store 120 and its planogram 134 and/or per shelf of each store 120 and its planogram 134. The four-pixel coordinates allows the MLM 116 to determine when detected empty space pixel coordinates are within or enclosed by the empty space and if so, associate the corresponding item identifier provided in the control file or data structure.

An example, control file or control data structure 180 is shown in FIG. 1B. The file/data structure 180 identifies item identifiers as 3, 5, 26, and 12. 3 corresponds to item name P 1 and item identifier 142 as shown in FIG. 1C; 5 corresponds to item name P 2 and item identifier 143 as shown in FIG. 1C; 26 corresponds to item name P 3 and item identifier 144 as shown in FIG. 1C; and 12 corresponds to item name P 4 and item identifier 145 as shown in FIG. 1C. The file/data structure 180 includes hardcoded pixel coordinates for each item item on each shelf, as discussed above, for a given item identifier and its corresponding shelf. MLM 116 can use the file/data structure 180 to disambiguate for a given empty space the correct item identifier by matching item and shelf positional information for a given shelf to a given item identifier when the MLM 116 is unable to determine a given item identifier for a given empty space of a shelf. During training, MLM 116 factors into the input features the provided file/data structure 180 to produce the expected output, which is empty space identifiers for empty spaces identified on a given shelf, shelf identifier for each empty space, empty space dimensions and/or pixel coordinates, and an item identifier that is associated with each empty space identifier. The control file/data structure 180 substantially increases the accuracy of the MLM 116 in correctly disambiguating between multiple item identifiers for a given shelf.

When the training image or training video are missing items in a given location, trainer 115 labels the dimensions and/or pixel coordinates of the empty area on the corresponding shelf and the item identifier that should have been in the empty area. These additional labels associated with the dimensions and/or pixel coordinates of the empty area and the corresponding item identifiers are labeled as the expected output from a MLM 116 when provided a training image or training video of a given shelf with the labeled input features and when provided the control file/data structure 180.

Trainer 115 then trains MLM 116 on a set of acquired training images or training video that includes each of the items on the shelves 122 in different orientations on their corresponding shelves 122 with the labeled input features, the labeled expected output for each training image, and the control file/data structure 180 when an empty space was detected in the training image or training video. The MLM 116 configures weights and an algorithm that when provided a given image of a given shelf 122 with an empty space and the control file/data structure 180 provides as output an item identifier for the missing item associated with the empty space and the dimensions and/or pixel coordinates of the empty space on the corresponding shelf 122 After training, MLM 116 is configured to receive the labeled input features with a corresponding image or video of a given shelf 122, to receive the control file/data structure 180, and to provide as output shelf identifiers, the item identifiers associated with any empty spaces present in the corresponding image or video along with the dimensions and/or pixel coordinates of each empty space for each item identifier.

When trainer 115 determines through a testing set of images or video that MLM 116 has reached an acceptable level of accuracy in predicting, from detected empty spaces in images of video of shelves 122, the item identifiers and corresponding shelf dimensions and/or pixel coordinates for each item identifier that is empty, trainer 115 releases MLM 116 for real-time restocking predictions. Once trainer 115 has released MLM 116 for real-time restocking predictions, retail manager 113 obtains real-time images and video from the cameras 121 of stores 120 for a given retailer. Retail manager 113 interacts with each retail server's API 135 to obtain the corresponding store planograms 134. Retail manager 113 then labels each image or video received from cameras 121 with the corresponding input features, which include the retailer identifier, store identifier, shelf identifiers, item type identifier per shelf identifier, and item identifier for the corresponding item type.

Retail manager 113 provides the control file/data structure 180 and images or video with the labeled input features as input to MLM 117. MLM 117 returns as output for a shelf identifier for a shelf represented in the images or video, an empty space identifier for each empty space detected on each shelf, the item identifier associated with each empty space, and the shelf dimensions and/or pixel coordinates of each empty space.

In an embodiment, retail manager 113 modifies the original image or video with labels that visually distinguish each empty space with an item name for the item identifier. Each empty space is also linked to or associated with known shelf dimensions and/or pixel coordinates that each item identifier is supposed to occupy on its corresponding shelf. In an embodiment, the known shelf dimensions are obtained from the corresponding planogram 134. The modified images and the shelf dimensions and/or pixel coordinates for each item associated with an empty space are stored by retail manager 113 in restocking data store 118.

Alert manager 117 identifies the entries made by retail manager 113 in restocking data store 118 and generates real-time report outs (e.g., reports and/or alerts) to store personnel of the corresponding store. Alert manager 117 interacts with a retail server's API 135 to obtain contact details for the store personnel and sends a real-time report or alert to personnel-operated devices that displays a restocking report and includes item identifiers and names for items in need of restocking along with a quantity of each item that should be restocked. Optionally, the restocking report includes the modified images for the shelves 122 with the item-named empty spaces and corresponding needed item identifiers.

FIG. 1C is a diagram 140 depicting example shelves stocked with example items, according to an example embodiment. The diagram represent an image 140 of a video frame 140 taken by a given camera 121 of a given set of shelves 151 and 152 in a given store 120. The top shelf 151 depicts 4 items 141, 142, 143, and 144 and the bottom shelf 152 depicts three items 145, 146, and 147. It is noted that there are a variety of visible empty spaces between the items.

Retail manager 113 receives the image 140 or video frame 140 in real time from a file, memory buffer, or data store that camera 121 streams to. Retail manager 113 obtains the metadata associated with the image 140 or video frame 140 and identifies the retailer. Retail manager 113 interacts with API 135 to obtain the planogram 134 for the corresponding store 120 and labels input features of the image 140 or video frame 140. Retail manager 113 uses the planogram 134 to obtain the control file/data structure 180 and provides the control file/data structure 180, the input features, and image 140 or video frame 140 as input to MLM 116. MLM 116 returns as output a shelf identifier for each shelf that includes an empty space, an empty space identifier for each empty space identified in the image 140 or video frame 140, dimensions and/or pixel coordinates of each empty space, and an item identifier associated with each empty space.

In an embodiment, retail manager 113 modifies the image 140 or video frame 140 to create a modified image 160 depicted in FIG. 1D. Superimposed within each empty space is a dotted-line box 142-1, 143-1, 144-1, 145-1, 146-1, and 147-1. Each box is also labeled with an item name P 1, P 2, P 3, P 4, P 5, and P 6 associated with a corresponding item identifier that should be in the box at the corresponding empty location. This provides a modified image 160 of the real-time image 140 or real-time video feed 140 taken of shelves 151 and 152 for the store 120. The modified image 160 provides visual guidance to store personnel as to what items P 1—P 6 need restocked on shelves 151 and 152 and a location on each shelf 151 and 152. The modified image 160 and the shelf dimensions and/or pixel coordinates of each empty space corresponding to each box 142-1, 143-1, 144-2, 145-1, 146-1, and 147-1 are stored by retail manager 113 in restocking data store 118.

Alert manager 117 receives notice that restocking data store 118 was updated with the modified image 160 and interacts with a corresponding retail server's API 135 to obtain contact information for store restocking personnel on duty at store 120. Alternatively or additionally, alert manager 117 posts a report, notification, and/or alert along with the modified image 160 to a website monitored by store personnel of store 120.

FIG. 1E is a screenshot that depicts a restocking audit report 170 of shelves depicted in FIG. 1C, according to an example embodiment. Each labeled empty space shown in modified image 160 of FIG. 1D is listed in the report generated by alert manager 117 from the restocking data store 118. For example, the item identifier 142 associated with P 1 is listed in the report as being a specific product or item name of P 1, a specific size 16 oz, and requiring restocking of two of the specific item names on shelf 151, which is illustrated in modified image 160 and which can also be included in the line entry of P 1 of report 170. Notice that P 2 and P 3 as shown in modified image 160 are adjacent to one another and personnel of the store would not really know how much of each item to restock the shelves by manual visual inspection unless they could recall from memory. MLM 116 is able to accurately predict and identify two adjacent empty spaces rather than one single empty space on shelf 151 with boxes 143-1 and 144-1. Also, the sizes, dimensions, and/or pixel coordinates of the empty spaces are provided by MLM 116 using the shelf dimensions and/or pixel coordinates associated with each item identifier 143 and 144, such that retail manager 113 can draw the sizes of the empty spaces adjacent to one another and size according to the shelf empty space sizes provided by MLM 116. In an embodiment, retail manager 113 uses the pixel coordinates associated with each item type on a given shelf obtained from the control file/data structure 180 to draw the sizes of each empty space. Alert manager 117 can calculate the quantity of each item needed from the size of the empty space and a known size of each item.

In an embodiment, Alert manager 117 counts the items of each unique item identifier that appear on the shelf in the modified image 160 and uses known dimensions and/or pixel coordinates associated with a missing item type to identify the missing quantity of the corresponding item using the size of the corresponding empty space for the missing item. In an embodiment, alert manager 117 uses a total count of items for a given item identifier on a given shelf that is noted in the corresponding planogram 134 to determine a missing count of the items needed for the corresponding empty space in the modified image without using the size of the corresponding empty space.

In an embodiment, 113-118 are provided over a cloud processing environment as a network-based service to store devices of store 120. This network-based service can also be provided to retailer devices such as retail server 130 through the cloud processing environment. The devices can include mobile devices, tablets, terminals, servers, wearable processing devices, etc.

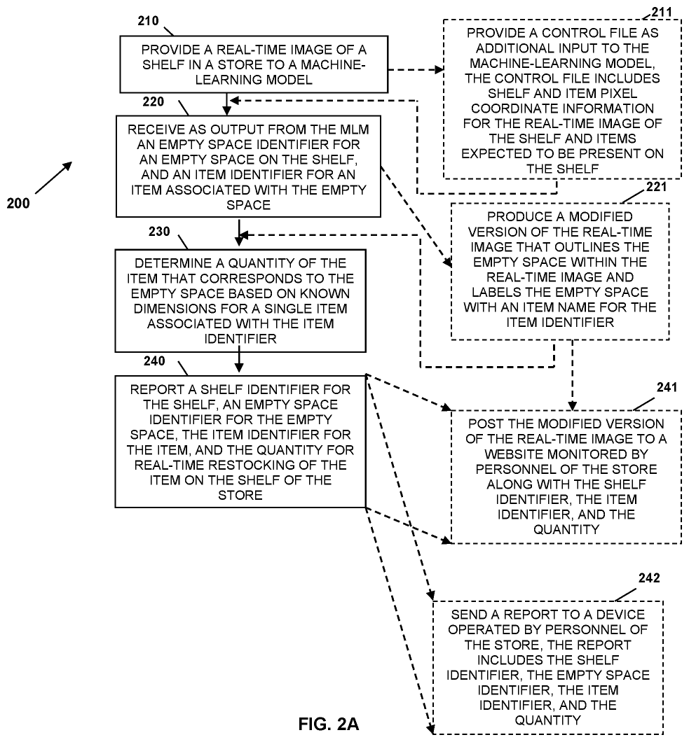

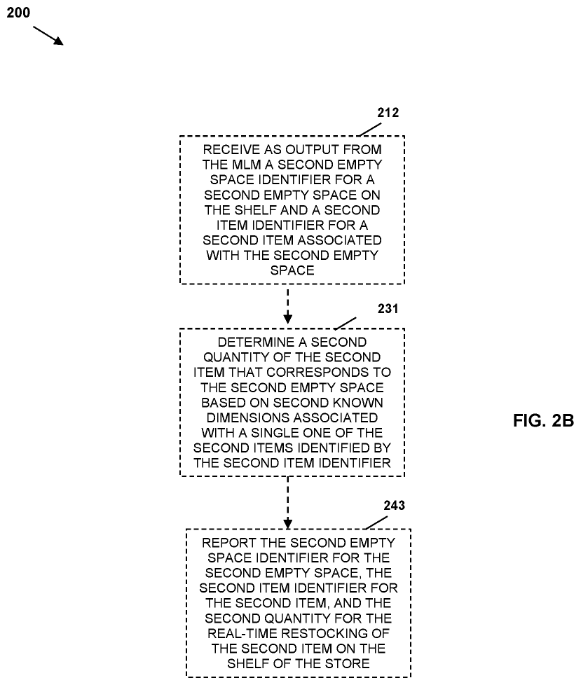

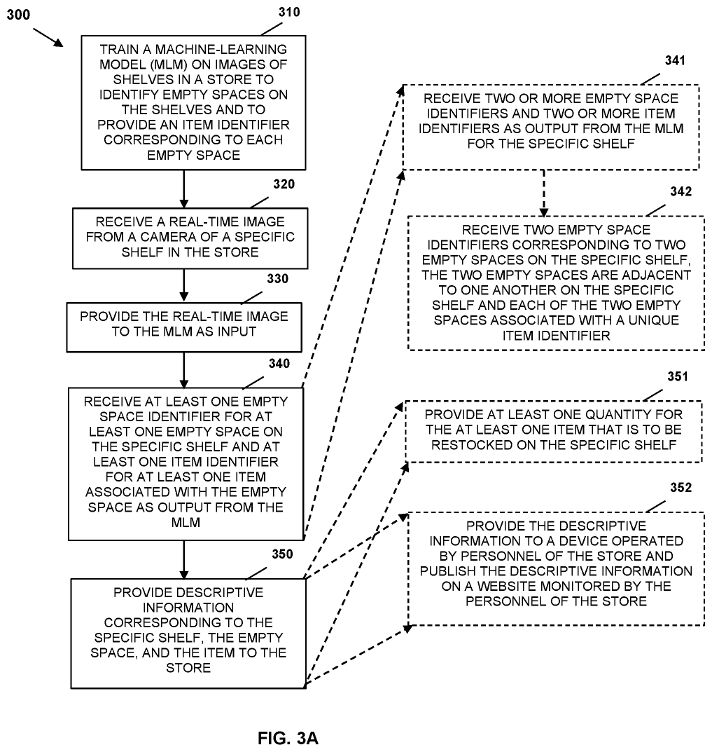

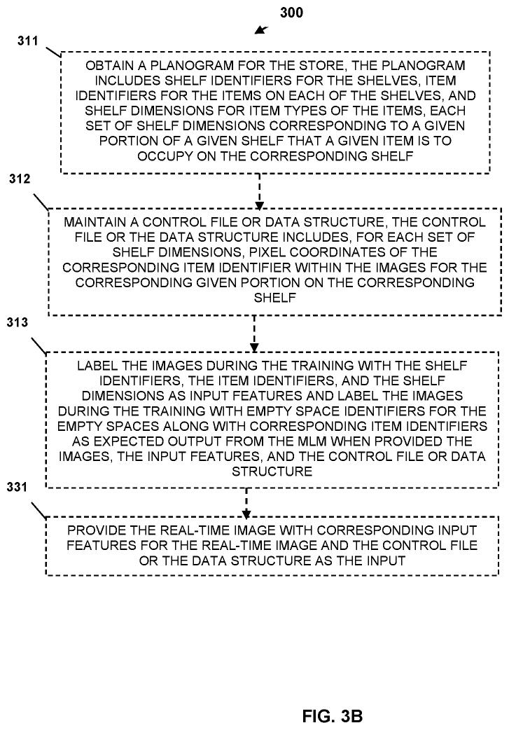

The above-referenced embodiments and other embodiments are now discussed with reference to FIGS. 2A, 2B, 3A, and 3B. FIGS. 2A and 2B are flow diagrams of a method 200 for computer vision shelf auditing, according to an example embodiment. The software module(s) that implements the method 200 is referred to as an “item restocking shelf auditor.” The item restocking shelf auditor is implemented as executable instructions programmed and residing within memory and/or a non-transitory computer-readable (processor-readable) storage medium and executed by one or more processors of a device or set of devices. The processor(s) of the device(s) that executes the item restocking shelf auditor are specifically configured and programmed to process the item restocking shelf auditor. The item restocking shelf auditor can have access to one or more network connections during its processing. The network connections can be wired, wireless, or a combination of wired and wireless.

In an embodiment, the item restocking shelf auditor executes cloud 110 or server 110. In an embodiment, the item restocking shelf auditor executes on a specific retail server 130.

In an embodiment, the item restocking shelf auditor is one, all, or some combination of 113, 114, 115, 116, and/or 117. In an embodiment, item restocking shelf auditor presents another, and in some ways, an enhanced processing perspective from that which was discussed above with 113-118 of system 100.

At 210 (shown in FIG. 2A), the item restocking shelf auditor provides a real-time image of a shelf in a store to an MLM 116. The real-time image can be part of a video such as a video frame. The real-time image is captured by a camera 121 of a store 120. The camera 121 has its field-of-view focused on a single shelf or a set of shelves within the store 120.

In an embodiment, at 211 (shown in FIG. 2A), the item restocking shelf auditor provides a control file as additional input to the MLM 116. The control file includes shelf and item pixel coordinate information for the real-time image of the shelf and items expected to be present on the shelf. An example, control file or data structure was shown as 180 in FIG. 1B and discussed above.

In an embodiment, at 212 (shown in FIG. 1B), the item restocking shelf auditor receives as output from the MLM 116 a second empty space identifier for a second empty space on the shelf and a second item identifier for a second item identifier for a second item associated with the second empty space. That is, the MLM 116 identifies 2 empty spaces on the shelf of the store 120. These 2 empty spaces can be adjacent to one another, as illustrated in FIG. 1D with 143-1 and 144-1 or 146-1 and 147-1. The 2 empty spaces can also be non-adjacent, as illustrated in FIG. 1D with 142-1 and 143-1; 142-1 and 144-1; 145-1 and 146-1; or 145-1 and 147-1.

At 220 (shown in FIG. 2A), the item restocking shelf auditor receives as output from the MLM 116 an empty space identifier for an empty space on the shelf, and an item identifier for an item associated with the empty space. That is, the MLM 116 uniquely identifies the empty space as being associated with a unique item type have a unique item identifier.

In an embodiment, at 221 (shown in FIG. 2A), the item restocking shelf auditor produces a modified version of the real-time image that outlines the empty space within the real-time image and labels the empty space with an item name for the item identifier. An example modified image was shown as 160 in FIG. 1D and discussed above.

At 230 (shown in FIG. 2A), the item restocking shelf auditor determines a quantity of the item that corresponds to the empty space based on known dimensions for a single item associated with the item identifier. This can be done in a number of manners, such as by counting the items present in the real-time image and using an item count associated with a planogram for the store 120 to determine the quantity. Additionally, dimensions associated with the items associated with the item identifier on the shelf can be acquired from the planogram and/or the control file or data structure discussed in embodiment 211 and compared to dimensions associated with the empty space to resolve the quantity.

In an embodiment of 212 and 230, at 231 (shown in FIG. 1B), the item restocking shelf auditor determines a second quantity of the second item that corresponds to the second empty space based on second known dimensions associated with a single one of the second items identified by the second item identifier.

At 240 (shown in FIG. 2A), the item restocking shelf auditor reports a shelf identifier for the shelf, an empty space identifier for the empty space, the item identifier for the item, and the quantity for real-time restocking of the item on the shelf of the store 120. This reporting permits near real-time restocking of the item on the shelf by store personnel.

In an embodiment, at 241 (shown in FIG. 2A), the item restocking shelf auditor post the modified version of the real-time image to a website monitored by personnel of the store along with the shelf identifier, the item identifier, and the quantity. This can include both the report illustrated in FIG. 1E and the modified image illustrated in FIG. 1D.

In an embodiment, at 242 (shown in FIG. 2A), the item restocking shelf auditor sends a report to a device operated by personnel of the store 120. The report includes the shelf identifier, the empty space identifier, the item identifier, and the quantity.

In an embodiment of 231 and 240, at 243 (shown in FIG. 2B), the item restocking shelf auditor reports the second empty space identifier for the second empty space, the second item identifier for the second item, and the second quantity for the real-time restocking of the second item on the shelf of the store 120. So, a single shelf of a store that includes different items of different quantities can be identified by item restocking shelf auditor and reported to the store personnel for near real-time restocking.

FIGS. 3A and 3B are flow diagrams of a method 300 for computer vision shelf auditing, according to an example embodiment. The software module(s) that implements the method 300 is referred to as a “shelf restocking manager.” The shelf restocking manager is implemented as executable instructions programmed and residing within memory and/or a non-transitory computer-readable (processor-readable) storage medium and executed by one or more processors of a device or set of devices. The processor(s) of the device that executes the shelf restocking manager are specifically configured and programmed to process the AR order assistance service. The shelf restocking manager can have access to one or more network connections during its processing. The network connections can be wired, wireless, or a combination of wired and wireless.

In an embodiment, the device that executes shelf restocking manager is cloud 110 or server 110. In an embodiment, the device that executes the shelf restocking manager is a specific retail server 130.

In an embodiment, the shelf restocking manager is all of, or some combination of, 113, 114, 115, 116, 117, and/or method 200. The shelf restocking manager presents another and, in some ways, an enhanced processing perspective from that which was described above for 113-118 of system 100 and/or method 200.

At 310 (shown in FIG. 3A), the shelf restocking manager trains an MLM 116 on images of shelves in a store 120 to identify empty spaces on the shelves and to provide an item identifier corresponding to each empty space. The training was discussed above with respect to system 100 and trainer 115.

In an embodiment, at 311 (shown in FIG. 3B), the shelf restocking manager obtains a planogram 134 for the store 120. The planogram 134 includes shelf identifiers for the shelves, item identifiers for items on each of the shelves, and shelf dimensions for item types of items. Each set of shelf dimensions corresponds to a given portion of a given shelf that a given item is to occupy on the corresponding shelf.

In an embodiment of 311 and at 312 (shown in FIG. 3B), the shelf restocking manager maintains a control file or a data structure. The control file or the data structure includes, for each set of shelf dimensions, pixel coordinates of the corresponding item identifier within the images for the corresponding given portion on the corresponding shelf.

In an embodiment of 312 and at 313 (shown in FIG. 3B), the shelf restocking manager labels the images during the training with the shelf identifiers, the item identifiers, and the shelf dimensions as input features. The shelf restocking manager also labels during the training with empty space identifiers for the empty spaces along with corresponding item identifiers as the expected output from the MLM 116 when provided the images, the input features, and the control file or the data structure.

At 320 (shown in FIG. 3A), the shelf restocking manager receives a real-time image from a camera 121 of a specific shelf in the store 120. The image can be streamed directly from the camera 121 to a memory buffer or a file accessible to the shelf restocking manager.

At 330 (shown in FIG. 3A), the shelf restocking manager provides the real-time image to the MLM 116 as input. The trained MLM 116 processes the input to produce identification of any empty spaces on the specific shelf and item identifiers for each of any identified empty spaces on the specific shelf.

In an embodiment of 313 and 330, at 331 (shown in FIG. 3B), the shelf restocking manager provides the real-time image with the corresponding input features for the real-time image and the control file or the data structure as the input. The control file or the data structure permits the MLM 116 to disambiguate between multiple item identifiers that require restocking, and which are associated with two adjacent and different empty spaces on the specific shelf as was discussed above.

At 340 (shown in FIG. 3A), the shelf restocking manager receives at least one empty space identifier for at least one empty space on the specific shelf and at least one item identifier for at least one item, which is associated with the empty space. This information is received as output from the MLM 116.

In an embodiment, at 341 (shown in FIG. 3A), the shelf restocking manager receives two or more empty space identifiers and two or more item identifiers as output from the MLM 116 for the specific shelf. That is, multiple items require restocking on the specific shelf based on the real-time image.

In an embodiment of 341 and at 342 (shown in FIG. 3A), the shelf restocking manager receives two empty space identifiers corresponding to two empty spaces on the specific shelf. The two empty spaces are adjacent to one another on the specific shelf and each of the two empty spaces is associated with a unique and different item identifier.

At 350 (shown in FIG. 3A), the shelf restocking manager provides descriptive information corresponding to the specific shelf, the empty space, and the item to the store 120. That is, the identifiers are mapped to descriptive information and provided to the store 120 so that personnel of the store can readily identify the shelf, the empty space, and the item that needs to be restocked.

In an embodiment, at 351 (shown in FIG. 3A), the shelf restocking manager provides at least one quantity for the item that is to be restocked on the specific shelf. In this case, for each identified empty space, a different item identifier and corresponding item quantity are provided to the store 120; this can be a single empty space and a single item quantity for a single item on the specific shelf or more than one empty space with a specific item quantity for each item.

In an embodiment, at 352 (shown in FIG. 3A), the shelf restocking manager provides the descriptive information to a device operated by personnel of the store 120. The shelf restocking manager also publishes the descriptive information on a website that is monitored by the personnel of the store 120.

In an embodiment of 313 and 330, at 331 (shown in FIG. 3B), the shelf restocking manager provides the real-time image with corresponding input features for real-time image

It should be appreciated that where software is described in a particular form (such as a component or module) this is merely to aid understanding and is not intended to limit how software that implements those functions can be architected or structured. For example, modules are illustrated as separate modules, but can be implemented as homogenous code, as individual components, some, but not all of these modules can be combined, or the functions can be implemented in software structured in any other convenient manner.

Furthermore, although the software modules are illustrated as executing on one piece of hardware, the software can be distributed over multiple processors or in any other convenient manner. The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
providing a real-time image of a shelf in a store to a machine-learning model (MLM) as input;
receiving as output from the MLM an empty space identifier for an empty space on the shelf, and an item identifier for an item associated with the empty space;
determining a quantity of the item that corresponds to the empty space based on known dimensions for a single item associated with the item identifier; and
reporting a shelf identifier for the shelf, the empty space identifier for the empty space, the item identifier for the item, and the quantity for real-time restocking of the item on the shelf of the store.

2. The method of claim 1, wherein providing further includes providing a control file as additional input to the MLM, wherein the control file comprises shelf and item pixel coordinate information for the real-time image of the shelf and items expected to be present on the shelf.

3. The method of claim 1, wherein receiving further includes producing a modified version of the real-time image that outlines the empty space within the real-time image and labels the empty space with an item name for the item identifier.

4. The method of claim 4, wherein reporting further includes posting the modified version of the real-time image to a website monitored by personnel of the store along with the shelf identifier, the empty space identifier, the item identifier, and the quantity.

5. The method of claim 1, wherein reporting further includes sending a report to a device operated by personnel of the store, wherein the report comprises the shelf identifier, the empty space identifier, the item identifier, and the quantity.

6. The method of claim 1, wherein receiving further includes receiving as output from the MLM a second empty space identifier for a second empty space on the shelf and a second item identifier for a second item associated with the second empty space.

7. The method of claim 6, wherein determining further includes determining a second quantity of the second item that corresponds to the second empty space based on second known dimensions associated with a single one of the second items identified by the second item identifier.

8. The method of claim 7, wherein reporting further includes reporting the second empty space identifier for the second empty space, the second item identifier for the second item, and the second quantity for the real-time restocking of the second item on the shelf of the store.

9. A method, comprising:
training a machine-learning model (MLM) on images of shelves in a store to identify empty spaces on the shelves and to provide an item identifier corresponding to each empty space;
receiving a real-time image from a camera of a specific shelf in the store;
providing the real-time image to the MLM as input;
receiving at least one empty space identifier for at least one empty space on the specific shelf and at least one item identifier for at least one item associated with the at least one empty space as output from the MLM; and
providing descriptive information corresponding to the specific shelf, the at least one empty space, and the at least one item to the store.

10. The method of claim 9, wherein training further includes obtaining a planogram for the store, wherein the planogram comprises shelf identifiers for the shelves, item identifiers for items on each of the shelves, and shelf dimensions for item types of the items, wherein each set of shelf dimensions corresponding to a given portion of a given shelf that a given item identifier is to occupy on the corresponding shelf.

11. The method of claim 10, wherein obtaining further includes maintaining a control file or data structure, wherein the control file or the data structure comprises, for each set of shelf dimensions, pixel coordinates of the corresponding item identifier within the images for the corresponding given potion on the corresponding shelf.

12. The method of claim 11, wherein training further includes labeling the images during the training with the shelf identifiers, the item identifiers, and the shelf dimensions as input features and labeling the images during the training with empty space identifiers for the empty spaces along with corresponding item identifiers as expected output from the MLM when provided the images, the input features, and the control file or the data structure.

13. The method of claim 12, wherein providing the real-time image further includes providing the real-time image with corresponding input features for the real-time image and the control file or the data structure as the input.

14. The method of claim 9, wherein receiving the at least one empty space identifier further includes receiving two or more empty space identifiers and two or more item identifiers as output from the MLM for the specific shelf.

15. The method of claim 14, wherein receiving two or more empty space identifiers further includes receiving two empty space identifiers corresponding to two empty spaces on the specific shelf, wherein the two empty spaces are adjacent to one another on the specific shelf and each of the two empty spaces associated with a unique item identifier.

16. The method of claim 9, wherein providing the descriptive information further includes providing at least one quantity for the at least one item that is to be restocked on the specific shelf.

17. The method of claim 9, wherein providing the descriptive information further includes providing the descriptive information to a device operated by personnel of the store and publish the descriptive information on a website monitored by the personnel of the store.

18. A system, comprising:
cameras;
a server comprises at least one processor and a non-transitory computer-readable storage medium;
the non-transitory computer-readable storage medium comprises executable instructions;
the executable instructions when executed by the at least one processor from the non-transitory computer-readable storage medium cause the at least one processor to perform operations comprising:
receiving a real-time image from at least one camera depicting a shelf of a store;
obtaining a planogram for the store;
labeling the real-time image with input features to provide a modified image based on the planogram, wherein the input features comprise a shelf identifier for the store and item identifiers for items that are to be stocked on the shelf;
providing the modified image to a machine-learning model (MLM) as input;
receiving as output from the MLM one or more empty space identifiers for one or more empty spaces identified in the modified image for the shelf and one or more item identifiers, each item identifiers associated with a specific empty space identifier;
determining from the empty space identifiers specific quantities for each of one or more items associated with the one or more item identifiers that are to be restocked on the shelf based on known dimensions associated with each of the one or more items and based on dimensions associated with each of the empty spaces; and
reporting descriptive information for the shelf identifier, each of the one or more item identifiers, each of the specific quantities, and each empty space identifier.

19. The system of claim 18, wherein the operations corresponding to the reporting further includes reporting the descriptive information to a device operated by personnel of the store and publishing the descriptive information on a website monitored by the personnel of the store.

20. The system of claim 18, wherein the server is one of several additional servers that cooperate as a cloud processing environment and providing the operations through the cloud processing environment as a network-based service to store devices of the store.
